(19) United States
(12) Patent Application Publication
(10) Pub. No.: US 2005/0021970 A1
(43) Pub. Date: Jan. 27, 2005

(54) Embedded data layers

(76) Inventors: Curtis Reese, Boise, ID (US); John R. Hatten, Boise, ID (US); Brett A. Green, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/623,878

(22) Filed: Jul. 21, 2003

(51) Int. Cl. H04L 9/00

(52) U.S. Cl. 713/176

(57) ABSTRACT

An improved data embedding and watermarking method and apparatus for images is described that allows for multiple levels of data to be encoded and retrieved, increasing image data content and information in a manner that cannot be lost or separated from the image. The various embodiments include images with two or more data fields/layers watermarked into them or within one or more of their sub-images/objects and methods and apparatus for encoding and decoding the multiple data fields utilizing multiple layer watermarking. Additionally, embodiments of the present invention associate the multiple layers of data directly with an image or sub-image allowing the data to be specific to the image/sub-image and contextual, reducing the potential for reader misunderstanding and improving communication.

### FIELD OF THE INVENTION

The present invention relates generally to data layer embedding in images.

### BACKGROUND

Images or text (referred to herein as images) are typically formed in modern systems by generating and displaying the component pixels of the image. With modem printing devices, such as, but not limited to, industrial printers, plotters, facsimile machines, laser printers, or ink jet printers (referred to herein collectively as printers), this image is typically formed on a print medium by the placement of pixels on the print medium with one or more printing toners, inks, or transfer/donor materials from a print ribbon (for example, plastic tape based label maker). Alternatively the pixels of the image can be brought out of the print medium itself by exposing it to a chemical, heat, or light based process in the varying strengths and patterns of the pixels of desired image (for example, thermal printers, photographic films, lithography, and etching).

Multiple methods of coding information into the pixels of images in manners that minimally change the underlying image and how it is perceived by human viewing exist and are generally referred to as steganography and/or watermarking (referred to herein as watermarking). Watermarking of images has been generally used for cryptography, security/authenticity of an image, rights management, tamper-proofing an image, and for proof of origin of an image.

The coding rate of a watermark, the relative amount of secret information that can be reliably embedded in the image, typically involves a tradeoff with visual quality and robustness. A higher coding rate allows more information to be embedded in the image, but tends to reduce the visual quality of the image and robustness in decoding the message. Conversely, a lower coding rate tends to provide less information, but the image has a higher visual quality and the decoding is more robust. Because of the image quality and robustness issues watermarking has typically been utilized to encode a small amount of data into an image with a lower coding rate. Watermarking also typically encoded the image as a whole to improve image quality, robustness, and data content by utilizing as large an image area as possible. As stated above, it is desirable, however, to perform hardcopy watermarking that is robust, has a high coding rate, and yet has a high visual quality to the resulting image. Several new methods of watermarking have been allowing for these qualities. One such method of watermark encoding that has a high coding rate, while being generally robust and having a high visual quality, and yet can be used in multiple transform domains, is described in U.S. Patent Application Pub. No. US 2002/0176599, published Nov. 28, 2002, titled “Hardcopy Watermarking”, by Levy et al., which is commonly assigned.

In many situations there is information or data that is associated with an image or the content or one or more elements in an image. For example, the date and location of an image, the person, place, or subject matter of an image. In advertising or in other commercial images this associated information may include the commercial details or various specifications of the pictured subject; for example, contact information, size, availability, and/or prices.

A problem with this image information or image “metadata” is that it is typically not permanently associated with the image and can be lost or, in the case of advertising or commercial images, not readily available for reference or presentation when the image is used or shown. This is particularly a problem with advertising or commercial images in that in many cases the image or resulting print medium is composed of multiple sub-images that can come from different sources and/or vendors. Additionally, text space or alternative print/presentation space on the print medium is typically at a premium and not all of the associated information may be able to be printed, or if it is printed is not directly associated with the image or sub-image it refers to and therefore may be misinterpreted by the reader. Furthermore, as stated above, it is often desired to associate multiple different types of common information in differing information fields (such as date, title, location, subject matter, etc.) with a given image or with each image of a set of images. This is particularly the case in advertising or commercial images where documents or advertising flyers are composed for specific purposes by retrieving the images from databases or repositories of images. The advertising or commercial associated information content may also vary depending on promotions, sales, region, presenter, vendor and/or advertiser, etc.

For the reasons stated above, and for other reasons stated below that will become apparent to those skilled in the art upon reading and understanding the present specification, there is a need in the art for an improved method for embedding associated information with images, and in particular commercial or advertising images.

### SUMMARY

The various embodiments described herein facilitate steganographic embedding or watermarking of multiple data fields or data layers (image metadata) in an image or in one or more of the sub-images/objects (component images) contained in the image. The various embodiments include images with two or more data fields embedded into them in two or more watermarks of differing encoding or defined within the same watermark at a high coding rate. In addition, other embodiments include two or more data fields defined within one or more sub-images/objects of the image. Methods and apparatus are also included for encoding and decoding the multiple data fields. In one embodiment of the present invention, an image includes multiple layers of metadata, each layer storing a data field of associated image data. In another embodiment of the present invention, one or more sub-images of an image include multiple layers of metadata, each layer storing a data field of associated image data. Embodiments of the present invention allow for the advantages of storing multiple layers of associated data embedded with an image or with each sub-image which would not otherwise be available allowing it to be retrieved by an end-user with a watermark enabled scanner or image reader (herein referred to as a reader). Additionally, embodiments of the present invention associate the multiple layers of data directly with an image or sub-image allowing the data to be specific to the image/sub-image and contextual, reducing the potential for reader misunderstanding and improving communication. Embodiments of the invention include apparatus and methods of varying scope.

### DESCRIPTION OF THE DRAWINGS

FIG. 1 is a simplified diagram of an image and data layers in accordance with an embodiment of the present invention.

FIG. 2 is a simplified diagram of an image with multiple sub-images/objects and data layers in accordance with another embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

Embodiments of the present invention utilize multiple transform or high coding rate watermarking to embed multiple metadata data fields in an image or in one or more of the objects (the component images) of the image. In one embodiment, images have two or more data fields embedded into them with each data field embedded in watermarks of differing encoding. In another embodiment images have two or more data fields embedded into them with each data field or defined within the same watermark, where the watermark has a high coding rate. In addition, other embodiments include two or more data fields defined within one or more sub-images/objects of the image and each embedded in two or more watermarks of differing encoding or within one watermark at a high coding rate. Methods and apparatus are also included for encoding and decoding the multiple data fields. In one embodiment of the present invention, an image includes multiple layers of metadata, each layer storing a data field of associated image data. In another embodiment of the present invention, one or more sub-images of an image include multiple layers of metadata, each layer storing a data field of associated image data. Embodiments of the present invention allow for the advantages of storing multiple layers of associated data embedded with an image or with each sub-image which would not otherwise be available allowing it to be retrieved by an end-user with a watermark enabled scanner or image reader. Additionally, embodiments of the present invention associate the multiple layers of data directly with an image or sub-image allowing the data to be specific to the image/sub-image and contextual, reducing the potential for reader misunderstanding and improving communication. Embodiments of the invention include apparatus and methods of varying scope.

As stated above, steganography and watermarking are methods of encoding information into the pixels of images in manners that are robust and have a high resulting image quality. Prior art watermarking typically encodes only a small amount of data in a single layer of watermark encoding at a low coding rate in an image to preserve image quality and robustness of the encoded data. This watermark is also generally encoded in the image as a whole. In addition, the use of watermarking in images and, in particular, printed material has suffered from issues of reliability in that they may be easily damaged and rendered unreadable. Newer systems of watermarking allow for high coding levels and increased robustness, while maintaining a high level of image quality. This allows for the encoding of multiple layers of data/data fields into a given image or into objects within a given image utilizing multiple watermarking methods that utilize differing transforms and/or encoding methods or within a single watermark when the watermark allows for a high coding level. This watermarking of multiple data levels, enabling storage of two or more data levels in a given image or sub-image/object in a printed page, allows for image information/associated information/“metadata” to be embedded and permanently associated with the image. Watermarking of sub-images/objects allows multiple levels of metadata to be provided for multiple arbitrary objects in a page and not just the entire page, allowing the information to be relevant to the scanned object and readily available for reference.

In the case of advertising or commercial images, embedding of multiple data levels in the image or objects of the image allows the related product information to be readily available for reference or presentation through use of a watermark enabled reader or viewer when the image is used or shown. This is particularly advantageous for advertising or commercial images for in many cases the image or resulting print medium is composed of multiple sub-images that can come from different sources and/or vendors, where advertising flyers are composed for specific purposes by the advertisers from stock images supplied by the vendor/manufacturer. The advertising or commercial associated information content may also vary depending on promotions, sales, region, presenter, vendor and/or advertiser. Additionally, text space or alternative print/presentation space on the print medium is typically limited and/or costly to the advertiser and/or specific vendor and not all of the associated information may be able to be printed, or if it is printed it is not directly associated with the image or sub-image it refers to and may therefore be misinterpreted by the reader. Furthermore, as stated above, it is often desired to associate multiple different types of common information in differing information fields (such as date, title, location, subject matter, etc.) with a given image or with each image of a set of images.

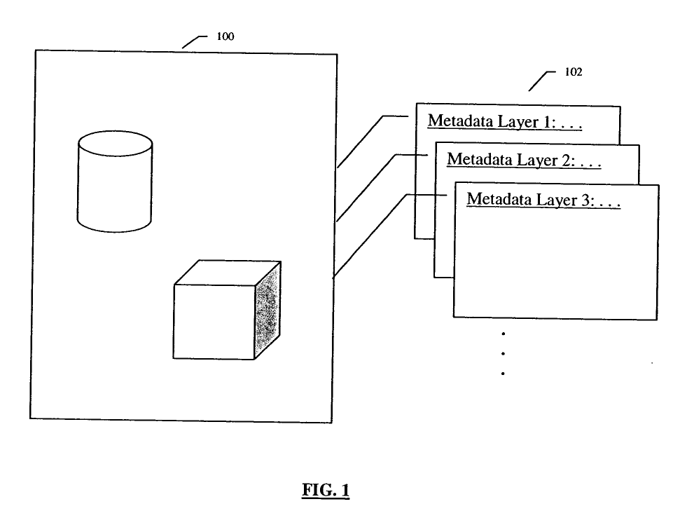

FIG. 1 is a simplified diagram of an image 100 of an embodiment of the present invention. In FIG. 1, the image 100 contains one or more graphical sub-elements or objects 104 (referred to herein as objects). Embedded into the image 100 is a watermark (not shown) that contains two or more layers of metadata 102 encoded into a composite watermark made up of multiple sub-watermarks of differing transforms/encodings or within a single watermark of a high coding rate, where the number of multiple watermarks or coding rate of the single watermark are configured to be large enough to encode the number and amount of data in the defined metadata layers. Each layer of metadata 102 can contain one or more data values or data areas. The metadata 102 stored in the watermark is accessible by a user through use of a watermark enabled reader.

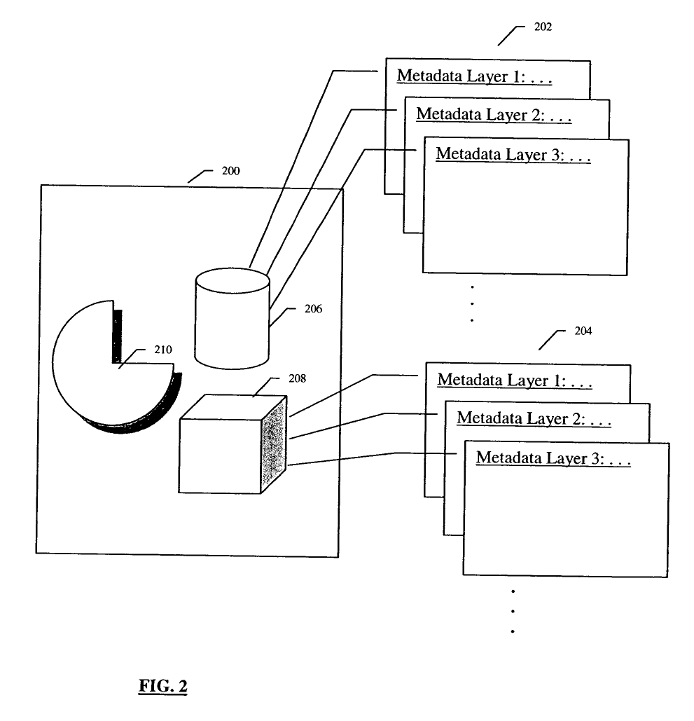

FIG. 2 is a simplified diagram of an image 200 of an embodiment of the present invention having one or more sub-images/objects that contain watermarks. In FIG. 2, the image 200 contains one or more graphical image objects 206, 208, and 210. Selected image objects 206, 208 each contain an embedded watermark (not shown) that each contains two or more layers of metadata 202, 204 encoded into a composite watermark made up of multiple sub-watermarks of differing transforms/encodings or within a single watermark of a high coding rate. The image objects 206, 208 that contain embedded watermarks can be arbitrarily selected and/or defined in the image 200. Each layer of metadata 202, 204 can contain one or more data values or data areas. The metadata of each watermarked object 206, 208 in the image 200 is accessible by a user by scanning the object with a watermark enabled reader to read the data layers embedded in their watermark. It is noted that the image 200 of FIG. 2 has multiple levels of metadata provided for multiple arbitrary objects in its page and not only just for the entire page.

Users may select the metadata layers of the images 100, 200 illustrated in FIGS. 1 and 2 to view after accessing them with a watermark enabled reader. Alternatively, readers or reader software may be configured to show or not show a given layer to the user, or only those layers accessed by them with the appropriate code/personal identification number (PIN). Additionally, in some embodiments, the information contained in the metadata layers may be used by the reader software to activate further processes, including, but not limited to, accessing the internet, accessing a database, accessing a program, enabling execution of an application or access to a computer system, and decoding encrypted content.

In other embodiments of the present invention, the multiple layers of metadata in a given object or image contain standardized data types in each different level. For one embodiment the data layers for an advertising oriented image or object are defined as follows: Layer One—Manufacturer specific information (such as, company name, business contact information, universal resource locator (URL), etc.), Layer Two—Object Characteristics (name, price, sizes available, colors available, etc.), Layer Three—Order information (catalog number, catalog page, matching accessories, substitutes if unavailable, retail locations, etc.), Layer Four—Manufacturer designated information (miscellaneous data included by the manufacturer).

To work with watermarking, client applications and printer drivers can be modified to incorporate the embedding of multiple layers of metadata into an image or the component objects of the image. Once the desired metadata is incorporated to an image or the objects of an image, it can be printed on multiple layer watermarking enabled printers. Manners of inserting the metadata in a client software application can include, but are not limited to, such methods as, right-clicking or double clicking on an image object to insert/associate the desired metadata, a menu selection to define metadata for a selected object, and a separate configuration file or application spreadsheet area containing metadata for selected/tagged objects or image areas that is to be read and incorporated upon printing.

To print from a client application to a multiple layer watermarking enabled printer, the client applications would utilize special modified printer drivers and generate a page description language (PDL) with extensions that would incorporate the metadata into the PDL data stream. The client application would print the image incorporating the defined objects and one or more of the associated metadata data layers (as optionally selected by the user and/or program) through the printer driver. The printer driver would generate a page description in a PDL, such as, but not limited to, PCL5, PCL6 or Postscript, and within the PDL page descriptions incorporate the defined metadata. Objects would be defined and transmitted to the multiple layer watermarking enabled printer in a raster or vector definition and the object definition in the PDL would include the metadata to be associated with the object in the final printed page. The multiple layer watermarking enabled printer would then generate the image and its objects from the PDL definition and embed each associated metadata layer within each defined object or page in a multiple layer watermark in that object or page image.

In another embodiment, as multiple data layers are being defined in association with one or more objects or the overall image, differing selected layers can either be printed embedded within the final image or printed separately within a separate text area or on a separate page. The selection of metadata layers to be printed can occur at the client application as part of the printing process/PDL generation. Alternatively, the metadata layers to be embedded or printed in plain text can be selected at the printer. In one embodiment, a print job containing all metadata layers is retained indefinitely at the printer and the print job and differing layers of metadata can be selected at the printer control panel and printed by users as desired. In one such embodiment the differing layers of metadata are selected/accessed at the printer by the entry of a user ID or PIN. Such differing printing of metadata layers would allow differing views or details for a joint project or document to be accessed and printed as desired by differing users or project teams. Such applications include, but are not limited to, joint project plans, architectural data, engineering drawings, and schematics. Again the selected metadata layers can be printed either separately or embedded with a multiple layer watermark in the printed document.

Embodiments of the present invention may include a set of computer-readable instructions stored on a computer-usable medium for execution by a processor. Examples of computer-usable medium include removable and non-removable magnetic media, optical media, dynamic random-access memory (DRAM), static random-access memory (SRAM), read-only memory (ROM) and electrically-erasable and programmable read-only memory (EEPROM or Flash).

It is noted that although the invention was described with specific reference to print image applications and apparatus it may be adapted for use with other imaging processes and applications and should be apparent to those skilled in the art with the benefit of the present disclosure.

### CONCLUSION

An improved data embedding and watermarking method and apparatus for images have been described that allows for multiple levels of data to be encoded and retrieved, increasing image data content and information in a manner that will not be separated from the image. The various embodiments described facilitate steganographic embedding or watermarking of multiple data fields or data layers (image metadata) in an image or in one or more of the sub-images/objects (component images) contained in the image. The various embodiments include images with two or more data fields embedded into them in two or more watermarks of differing encoding or defined within the same watermark at a high coding rate. In addition, other embodiments include two or more data fields defined within one or more sub-images/objects of the image. Methods and apparatus are also included for encoding and decoding the multiple data fields. In one embodiment of the present invention, an image includes multiple layers of metadata, each layer storing a data field of associated image data. In another embodiment of the present invention, one or more sub-images of an image include multiple layers of metadata, each layer storing a data field of associated image data. Embodiments of the present invention allow for the advantages of storing multiple layers of associated data embedded with an image or with each sub-image which would not otherwise be available allowing it to be retrieved by an end-user with a watermark enabled scanner or image reader (herein referred to as a reader). Additionally, embodiments of the present invention associate the multiple layers of data directly with an image or sub-image allowing the data to be specific to the image/sub-image and contextual, reducing the potential for reader misunderstanding and improving communication. Embodiments of the invention include apparatus and methods of varying scope.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. An image, comprising:
an image, wherein the image contains two or more layers of data encoded in a watermark.

2. The image of claim 1, wherein the two or more layers of data are encoded in a high coding rate watermark.

3. The image of claim 1, wherein the watermark contains two or more sub-watermarks, each sub-watermark of a differing encoding method and/or transform.

4. The image of claim 3, wherein each layer of the two or more layers of data are encoded into a selected sub-watermark.

5. The image of claim 1, wherein each of the two or more layers of data contain one or more data areas.

6. The image of claim 1, wherein the image contains one or more image objects, where at least one image object contains two or more layers of data encoded in a watermark.

7. The image of claim 1, wherein the two or more layers of data of the image includes at least one of a manufacturer information layer, an object characteristics layer, an order information layer, and a manufacturer designated layer.

8. An image, comprising:
an image, wherein the image contains one or more sub-images, where at least one sub-image contains two or more layers of data in a watermark.

9. The image of claim 8, wherein the two or more layers of data are encoded in a high coding rate watermark.

10. The image of claim 8, wherein the watermark contains two or more sub-watermarks, each sub-watermark of a differing encoding method and/or transform.

11. A method of watermarking an image, comprising:
encoding two or more layers of metadata into an image in a watermark.

12. The method of claim 11, wherein encoding two or more layers of metadata into an image in a watermark further comprises encoding two or more layers of metadata into an image in a high coding rate watermark.

13. The method of claim 11, wherein encoding two or more layers of metadata into an image in a watermark further comprises encoding two or more layers of metadata into an image in a watermark, where the watermark contains two or more sub-watermarks, each sub-watermark of a differing encoding method and/or transform.

14. The method of claim 13, wherein each layer of the two or more layers of metadata are encoded into a selected sub-watermark.

15. The method of claim 11, wherein encoding two or more layers of metadata into an image in a watermark further comprises encoding one or more data areas in at least one of the two or more layers of metadata.

16. The method of claim 11, further comprising:
encoding two or more layers of metadata in a watermark in one or more image objects of the image.

17. The method of claim 11, encoding two or more layers of metadata into an image in a watermark further comprises encoding at least one of a manufacturer information layer, an object characteristics layer, an order information layer, and a manufacturer designated layer.

18. A method of watermarking at least one sub-image of an image, comprising:
encoding the plurality of layers of data in a watermark in the at least one sub-image.

19. The method of claim 18, wherein encoding the plurality of layers of data in a watermark in the at least one sub-image further comprises encoding the plurality of layers of data in a high coding rate watermark.

20. The method of claim 18, wherein encoding the plurality of layers of data in a watermark in the at least one sub-image further comprises encoding the plurality of layers of data in a watermark containing a plurality of sub-watermarks, each sub-watermark encoded with a different encoding method and/or transform.

21. The method of claim 20, wherein each layer of the plurality of layers of data are encoded into a separate sub-watermark.

22. The method of claim 18, wherein encoding the plurality of layers of data in a watermark in the at least one sub-image further comprises encoding one or more data areas in the two or more layers of data of the at least one sub-image.

23. A computer-usable medium having computer-readable instructions stored thereon for execution by a processor to perform a method comprising:
encoding two or more layers of metadata into an image in a watermark.

24. The computer-usable medium of claim 23, wherein encoding two or more layers of metadata into an image further comprises encoding two or more layers of metadata in one or more image objects of the image, where each of the one or more image objects is encoded in a watermark.

25. The computer-usable medium of claim 23, wherein the two or more layers of metadata are encoded in a high coding rate watermark.

26. The computer-usable medium of claim 23, wherein the watermark contains two or more sub-watermarks, each sub-watermark of a differing encoding method and/or transform.

27. The computer-usable medium of claim 26, wherein each of the two or more layers of metadata are encoded into a selected sub-watermark.

28. A method of operating a printer, comprising:
receiving a print job containing an image and two or more layers of metadata; and
encoding the two or more layers of metadata into a watermark in an image.

29. The method of claim 28, wherein encoding the two or more layers of metadata into a watermark in an image further comprises encoding the two or more layers of metadata in a high coding rate watermark in an image.

30. The method of claim 28, wherein encoding the two or more layers of metadata into a watermark in an image further comprises encoding the two or more layers of metadata into a watermark containing a plurality of sub-watermarks, each sub-watermark encoded with a different encoding method and/or transform.

31. The method of claim 30, wherein each layer of the two or more of layers of metadata are encoded into a separate sub-watermark.

32. The method of claim 28, wherein encoding two or more layers of metadata into a watermark in an image further comprises encoding the two or more layers of metadata into a watermark in one or more image objects of the image.

33. The method of claim 28, wherein encoding two or more layers of metadata into a watermark in an image further comprises selecting a subset of the two or more layers of metadata and encoding the subset layers of metadata in the image.

34. The method of claim 33, wherein selecting a subset of the two or more layers of metadata and encoding the subset layers of metadata in the image further comprises printing the subset layers of metadata as text with the image.

35. The method of claim 33, wherein selecting a subset of the two or more layers of metadata and encoding the subset layers of metadata in the image further comprises selecting the subset of the two or more layers of metadata via user selection of the subset at the printer.

36. The method of claim 33, wherein selecting a subset of the two or more layers of metadata and encoding the subset layers of metadata in the image further comprises selecting the subset of the two or more layers of metadata by entry of a PIN and/or a user ID at the printer.

37. The method of claim 28, wherein receiving a print job containing an image and two or more layers of metadata further comprises receiving and retaining at the printer a print job containing an image and two or more layers of metadata.

38. The method of claim 28, wherein receiving a print job containing an image and two or more layers of metadata further comprises receiving a print job containing an image and two or more layers of metadata, wherein the print job is defined in a page description language (PDL) having at least one raster or vector data section and at least one metadata section.

39. The method of claim 38, wherein receiving a print job containing an image and two or more layers of metadata, wherein the print job is defined in a page description language (PDL) having at least one raster or vector data section and at least one metadata section further comprises receiving a print job containing an image and two or more layers of metadata, wherein the print job is defined in a page description language (PDL) having one or more image objects, each image object defined with a raster or vector data section and a metadata section.

40. The method of claim 38, wherein the page description language (PDL) is one of PCL5, PCL6, and Postscript.

41. A method of accessing data encoded in an image, comprising:
decoding a watermark containing two or more layers of data with a reader; and
selecting a subset of the two or more data layers to view.

42. The method of claim 41, further comprising:
selecting an image object having a watermark.

43. The method of claim 41, wherein decoding a watermark containing two or more layers of data with a reader further comprises decoding a high coding rate watermark containing two or more layers of data with a reader.

44. The method of claim 41, wherein decoding a watermark containing two or more layers of data with a reader further comprises decoding two or more layers of data from a watermark containing a plurality of sub-watermarks, each sub-watermark encoded with a different encoding method and/or transform.

45. The method of claim 41, wherein selecting a subset of the two or more data layers to view further comprises selecting a subset of the two or more data layers to view via one of a user input to the reader, a configuration input to the reader, and an input of a user ID and/or PIN to the reader.

46. The method of claim 41, further comprising:
executing a further process based on information incorporated in the selected subset of data layers.

47. The method of claim 46, wherein executing a further process based on information incorporated in the selected subset of data layers further comprises executing a further process to accomplish one of accessing the internet, accessing a database, accessing a program, enabling execution of an application, enabling access to a computer system, and decoding encrypted content.

48. A method of defining multiple layers of metadata for a watermark in an image, comprising:
associating an image with two or more layers of metadata in an application; and
encoding the image and two or more layers of metadata into a page description language (PDL) definition.

49. The method of claim 48, wherein encoding the image and two or more layers of metadata into a page description language (PDL) definition further comprises encoding the two or more layers of metadata into a page description language (PDL) definition for a high coding rate watermark.

50. The method of claim 48, wherein encoding the image and two or more layers of metadata into a page description language (PDL) definition further comprises encoding the two or more layers of metadata into a page description language (PDL) definition for a watermark containing a plurality of sub-watermarks, each sub-watermark encoded with a different encoding method and/or transform.

51. The method of claim 50, wherein each layer of the two or more of layers of metadata are encoded into a separate sub-watermark.

52. The method of claim 48, wherein encoding two or more layers of metadata and image into a page description language (PDL) definition further comprises encoding the two or more layers of metadata into a watermark of one or more image objects of the image.

53. The method of claim 48, wherein associating an image with two or more layers of metadata in an application further comprises associating one or more image objects of the image with two or more layers of metadata.

54. The method of claim 53, wherein associating one or more image objects of the image with two or more layers of metadata further comprises associating one or more image objects of the image with two or more layers of metadata, where the two or more layers of metadata are associated with each image object by selecting the image object and defining the metadata layers by one of a right click on the image object, selecting a menu item, entering the metadata in a spreadsheet page associated with the selected image object, and defining the metadata for the selected image object in an associated configuration file.

55. The method of claim 48, wherein the page description language (PDL) is one of PCL5, PCL6, and Postscript.

56. The method of claim 48, wherein encoding the image and two or more layers of metadata into a page description language (PDL) definition further comprises encoding the image and two or more layers of metadata into a page description language (PDL) definition, wherein the PDL contains at least one raster or vector data section and at least one metadata section.

57. The method of claim 56, wherein encoding the image and two or more layers of metadata into a page description language (PDL) definition, wherein the PDL contains at least one raster or vector data section and at least one metadata section further comprises encoding the image and two or more layers of metadata into a page description language (PDL) definition, wherein the PDL contains one or more image objects, each image object defined with a raster or vector data section and a metadata section.

58. The method of claim 48, wherein encoding the image and two or more layers of metadata into a page description language (PDL) definition further comprises selecting a subset of the two or more layers of metadata and encoding the subset layers of metadata in the PDL.
